(19) United States
(12) Patent Application Publication
(10) Pub. No.: US 2014/0040741 A1
(43) Pub. Date: Feb. 6, 2014

(54) Smart Auto-Completion

(71) Applicant: APPLE, INC., Cupertino, CA (US)

(72) Inventors: Marcel van Os, San Francisco, CA (US); May-Li Khoe, San Francisco, CA (US)

(73) Assignee: Apple, Inc., Cupertino, CA (US)

(21) Appl. No.: 13/886,942

(22) Filed: May 3, 2013

Related U.S. Application Data
(60) Provisional application No. 61/678,748, filed on Aug. 2, 2012.

(51) Int. Cl. G06F 3/0481; G06F 3/0484

(52) U.S. Cl. CPC G06F 3/0481; G06F 3/0484
USPC 715/719; 715/716; 715/780

(57) ABSTRACT

Auto-completion techniques are provided. In some embodiments, a multimedia object can be determined based upon a received textual input. A displayable representation of the multimedia object can be provided as an auto-complete suggestion. In response to user selection of the displayable representation, the received textual input can be replaced with a representation that enables the multimedia object to be accessed. In some embodiments, a mathematical operation can be performed based upon the received textual input. The result of the operation can be provided as an auto-complete suggestion. In response to user selection of the suggestion, the received textual input can be replaced with the result of the mathematical calculation.

This application claims priority to U.S. Provisional Application Ser. No. 61/678,748, filed Aug. 2, 2012, which is incorporated by reference herein in its entirety.

### TECHNICAL FIELD

### Background

The present disclosure relates generally to electronic devices and more particularly to auto-completion techniques.

Auto-completion typically refers to predicting a word or phrase that a user intends to input into an application based on partial input by the user. For example, when a user inputs the first letter or letters of a word into a word processor, an auto-completion application can compare the user's input to a list of known words that start with the same letter or letters, and provide the user with one or more of the known words as suggestions. If the provided suggestions include the user's intended word or phrase, the user can select the suggestion by, for example, a single keystroke. Upon selection, the auto-complete application can replace the user's partial input with the completed word.

Auto-completion applications can decrease the number of required keystrokes to complete a word or phrase which may increase typing speed and speed up user-interaction with applications such as word processors, web browsers, e-mail programs, search engine interfaces, source code editors, database query tools, command line interpreters, and the like.

### BRIEF SUMMARY

Certain embodiments of the invention are directed to auto-completion techniques.

Certain embodiments are described that provide for auto-completion of textual input using multimedia objects. In some embodiments, textual input can be received at an electronic device. Based upon the textual input, the electronic device can determine a multimedia object (e.g., an audio file, video file, image, calendar object, map object, contact card object, and the like). The multimedia object may be stored, for example, in a memory of the electronic device or externally in a memory of a remote server computer. The electronic device can provide a displayable representation of the multimedia object as an auto-complete suggestion. In some embodiments, the displayable representation can be provided as a textual or graphical representation. Upon receiving a user selection of the displayable representation of the multimedia object, the electronic device can replace the textual input with a representation that enables the multimedia object to be accessed. For example, the textual input can be replaced with the multimedia object itself (e.g., by embedding or attaching the object to a message), or with a link to the stored multimedia object (e.g., a hyperlink).

In some embodiments, displayable representations of multiple multimedia objects can be provided as auto-complete suggestions. For example, a list or other graphical arrangement of displayable representations can be provided such that the user can select one or more for auto-completion.

Certain embodiments are further described that provide for auto-completion of textual input using the result of a mathematical calculation. In some embodiments, an electronic device can perform a mathematical operation based upon received textual input. For example, the electronic device can determine a mathematical operation and one or more operands based upon the textual input. The electronic device can perform the mathematical operation using the one or more operands, and may provide the result of the mathematical operation as an auto-complete suggestion. Upon receiving user selection of the auto-complete suggestion, the textual input can be replaced with the result of the mathematical operation.

In some embodiments, multiple mathematical operations can be determined based upon the textual input. The mathematical operations can be performed by the electronic device using one or more determined operands, and the results of the mathematical operations may be provided as one or more auto-complete suggestions. Exemplary mathematical operations can include, but are not limited to, addition, subtraction, division, multiplication, exponentiation, trigonometric functions, unit conversion, currency conversions, interest calculations, and the like.

In some embodiments, the electronic device can provide auto-completion suggestions comprising any suitable combination of displayable representations of a multimedia objects, results of mathematical operations, and textual auto-completion suggestions for one or more words or phrases.

### BRIEF DESCRIPTION OF THE DRAWINGS

FIGS. 1-7 depict examples of techniques for providing auto-complete suggestions in a user interface according to some embodiments;

FIG. 8 depicts a simplified diagram of a system that may incorporate an embodiment of the invention;

FIG. 9 depicts a simplified flowchart depicting a method of providing auto-completion suggestions using multimedia objects according to embodiments of the invention;

FIG. 10 depicts a simplified flowchart depicting a method of providing auto-completion suggestions based upon the result of a mathematical calculation according to embodiments of the invention;

FIG. 11 depicts a simplified block diagram of a computer system that may incorporate components of a system for performing auto-completion according to embodiments of the invention; and

FIG. 12 depicts a simplified diagram of a distributed system for performing auto-completion according to embodiments of the invention.

### DETAILED DESCRIPTION

In the following description, for the purposes of explanation, specific details are set forth in order to provide a thorough understanding of embodiments of the invention. However, it will be apparent that various embodiments may be practiced without these specific details.

Certain embodiments of the invention are directed to auto-completion techniques. For example, certain embodiments are described that provide for auto-completion of textual input using multimedia objects. Textual input can be received at an electronic device. For example, a user can enter textual input at a user interface of the electronic device such as a keyboard or a touch sensitive interface including a software keyboard. As the user enters the textual input, the input may be mapped to a stored multimedia object (e.g., an audio file, video file, image, calendar object, and the like), and a displayable representation of the multimedia object can be provided to the user as an auto-complete suggestion. The user then has the option of selecting the auto-complete suggestion. In certain embodiments, the displayable representation may include a textual representation (e.g., one or more words) or a graphical representation (e.g., a graphical image) of the identified multimedia object. Upon receiving the user selection of the auto-complete suggestion (e.g., by a keystroke or other user input), the textual input can be replaced with a representation that enables the multimedia object to be accessed. For example, the textual input can be replaced with a link (e.g., a hyperlink) to the stored multimedia object. In some embodiments, the textual input can be replaced with the multimedia object itself (e.g., by embedding or attaching the multimedia object to a message).

Certain embodiments are further described that provide for auto-completion using the result of a mathematical calculation. In some embodiments, as the user enters textual input, the input may be mapped to a mathematical operation, and the result of the mathematical operation may then be provided as an auto-complete suggestion for the user to select. For example, based upon the textual input, an electronic device may determine a mathematical operation to be performed, and possibly one or more operands to be used for performing the mathematical operation. The electronic device can perform the operation using the one or more operands, and provide the result of the mathematical operation as an auto-complete suggestion to the user. The user then has the option of selecting the auto-complete suggestion. Upon receiving user selection of the suggestion (e.g., by a keystroke or other user input), the electronic device may replace the textual input with the result of the mathematical operation. Exemplary mathematical operations can include, but are not limited to, addition, subtraction, division, multiplication, exponentiation, trigonometric functions, unit conversion, currency conversions, interest calculations, and the like

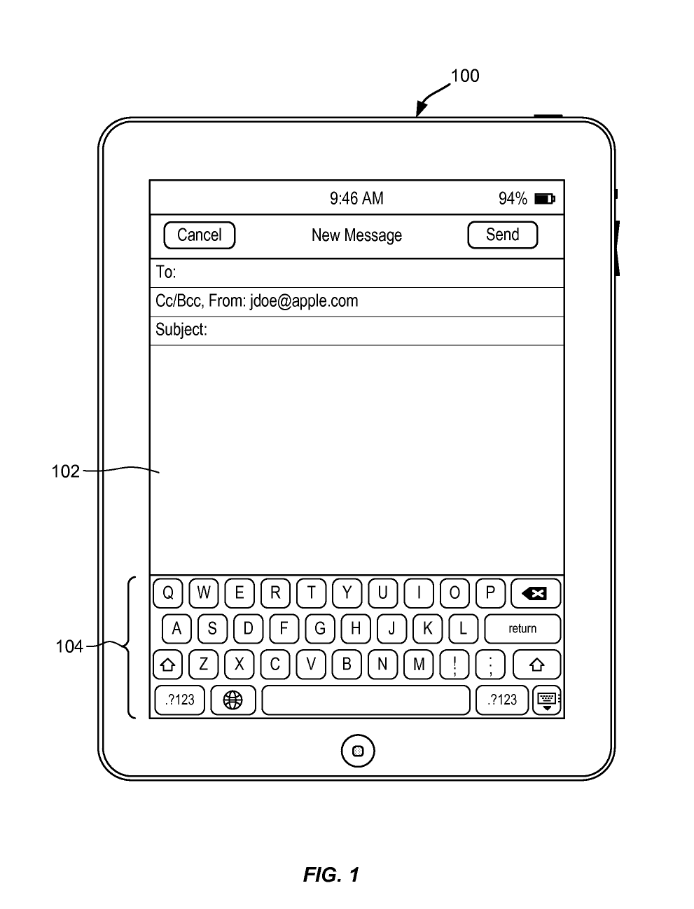

FIGS. 1-7 depict examples of techniques for providing auto-complete suggestions in a user interface according to some embodiments. The examples depicted in FIGS. 1-7 are not intended to be limiting.

In FIGS. 1-7, an electronic device 100 is shown displaying a software keyboard 104 overlaid on a user interface 102 corresponding to an application being executed by electronic device 100. In the examples shown in FIG. 1-7, the computing device is an iPad® device from Apple Inc. of Cupertino, Calif. In some alternative embodiments, electronic device 100 can be any other computing device including a portable or non-portable device. Exemplary embodiments of computing devices include, without limitation, the iPhone® and iPod Touch® devices from Apple Inc. of Cupertino, Calif., other mobile devices, desktop computers, kiosks, and the like.

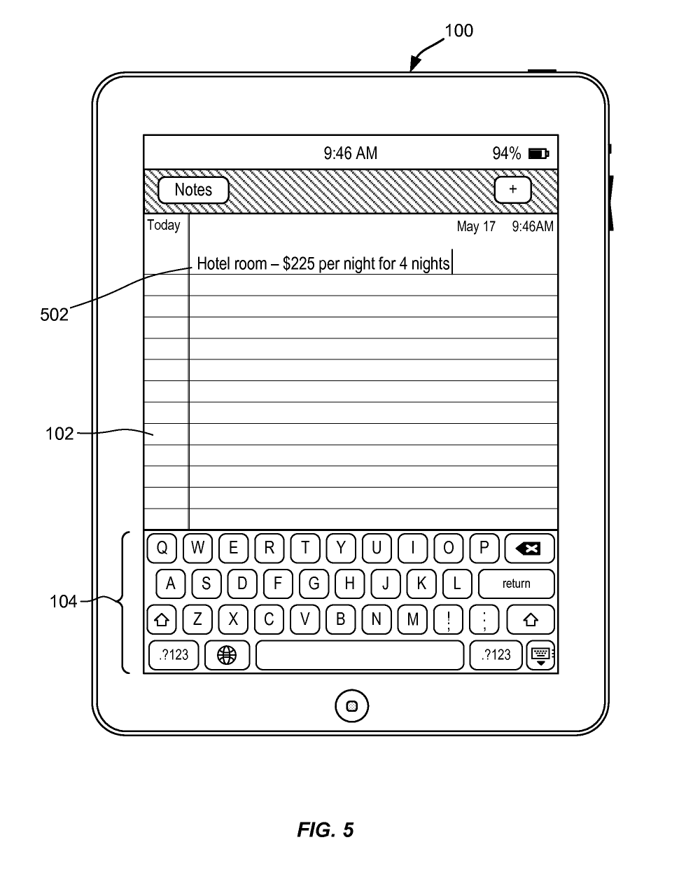

In FIGS. 1-4, the user interface 102 depicted by electronic device 100 is for an e-mail application and in FIGS. 5-7, the user interface 102 is for a “Notes” application. This, however, is not intended to be limiting. The auto-completion techniques described in the present disclosure may be used with any suitable application in which textual input can be entered by a user. Exemplary applications include, without limitation, text editors, word processors, web browsers, e-mail programs, search engine interfaces, source code editors, database query tools, command line interpreters, and the like.

In FIGS. 1-7, textual input can be provided by a user using software keyboard 104. This, however, is not intended to be limiting. The auto-completion techniques of the present disclosure may be used with any suitable application incorporating any suitable textual input devices. Exemplary textual input devices include, without limitation, desktop keyboards, laptop-size keyboards, thumb-sized keyboards, chorded keyboards, sofware keyboards, foldable keyboards, projection keyboards, voice recognition devices (e.g., a microphone coupled to voice recognition circuitry), individual letter selection devices, and the like.

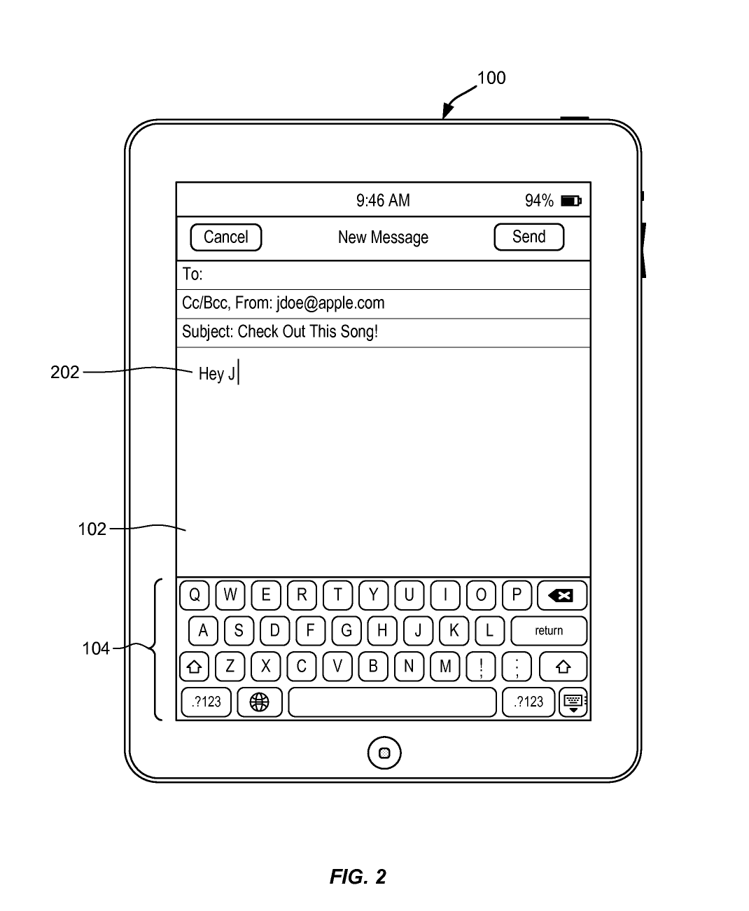

FIGS. 1-4 depict examples of providing auto-completion suggestions using multimedia objects according to some embodiments. In FIG. 1, a user interface 102 including a “New Message” interface for an e-mail application is depicted by electronic device 100. A software keyboard 104 is also displayed for facilitating text entry. In FIG. 2, a user has entered the textual input “Hey J” 202 in the e-mail application. As the user types “Hey J” 202, upon the input of the character “J,” an auto-completion processing may be triggered. In certain embodiments, this may cause electronic device 100 to perform processing to determine one or more auto-complete suggestions based upon the textual input. For example, processing may be triggered to determine if there are one or more multimedia objects that match the textual input and that can be provided as auto-complete suggestions. Processing may also be triggered to determine a possible mathematical operation to be performed. In certain embodiments, processing may also be triggered to identify other possible auto-complete suggestion.

For example, with respect to multimedia objects, auto-completion processing may be triggered that causes electronic device 100 to search an internal memory or an external memory of a remote server computer (e.g., a web-based server accessible via the internet) to identify multimedia objects that potentially match the textual input “Hey J” 202.

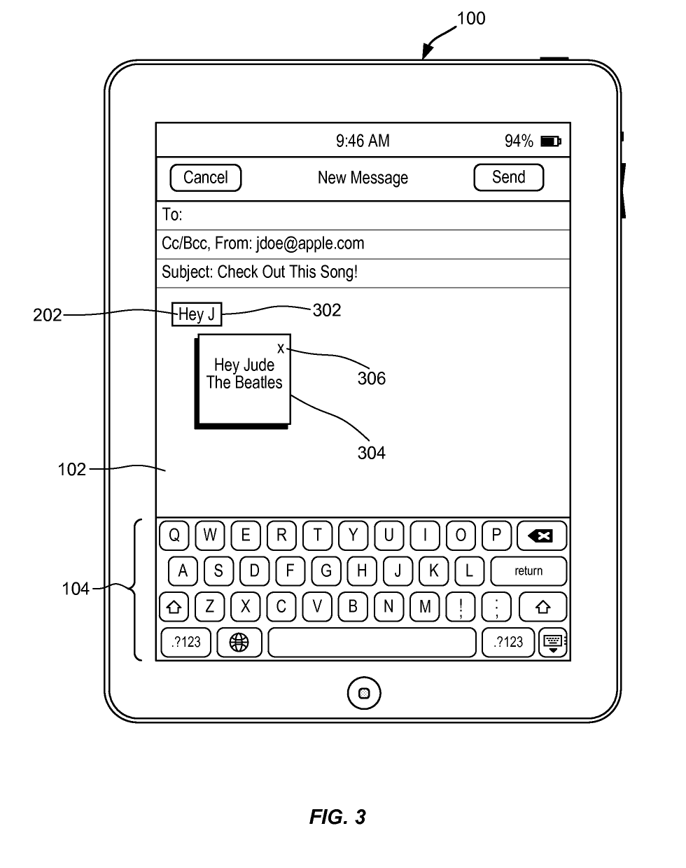

In FIG. 3, electronic device 100 has identified a stored multimedia object as an auto-complete match based upon the received textual input, namely an audio file of the song “Hey Jude” by The Beatles. As shown in FIG. 3, a displayable representation 304 of the multimedia object is provided to the user as an auto-complete suggestion on user interface 102. In some embodiments, electronic device 100 may determine an auto-complete suggestion for all or part of the original textual input 202. For example, if the original textual input included “Check out this song Hey J,” electronic device 100 may suggest an auto-completion of just “Hey J” as opposed to an auto-completion of the entire textual input. To indicate to the user which portions of the original textual input 202 correspond to the displayed auto-complete suggestion, the relevant portions of the textual input 202 may be highlighted 302, or the appearance altered in some form on user interface 102. The displayable representation 304 provided as the auto-complete suggestion may comprise a graphical representation (e.g., a graphical image) and/or a textual representation (e.g., one or more words) of the multimedia object.

If the user prefers not to have the original textual input 202 replaced by the auto-complete suggestion, displayable representation 304 may include a control 306 that the user may select using touch input to reject the auto-completion. In some embodiments, the auto-complete suggestion may be rejected by the user providing other forms of input such as a keystroke, mouse click, voice input, and the like. For example, if the user continues typing without selecting the auto-complete suggestion, the suggestion may be rejected. Moreover, in some embodiments, the auto-complete suggestion may be automatically rejected after the expiration of a predetermined time interval (e.g., a time-out function). Upon rejection of the auto-complete suggestion, displayable representation 304 may be removed from (i.e. no longer displayed on) user interface 102.

If the user wishes to replace the original textual input 202 with the auto-complete suggestion, the user may, for example, provide touch input at user interface 102 (e.g., by touching a region of displayable representation 304). In some embodiments, the user may select the auto-complete suggestion by providing other forms of input such as a keystroke, mouse click, voice input, and the like.

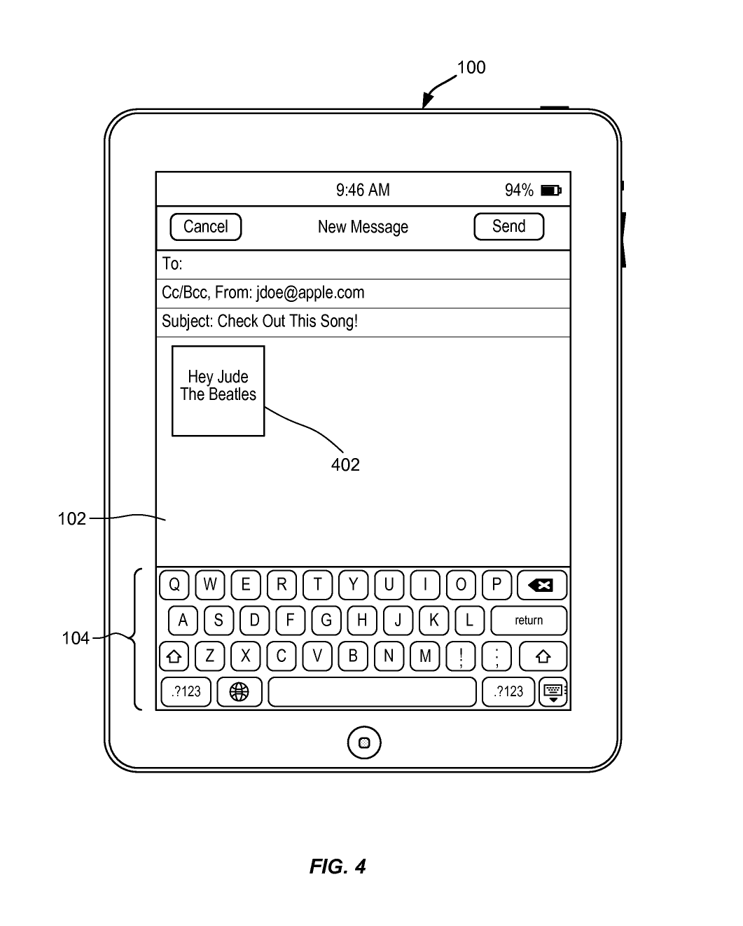

FIG. 4 shows the result of the user selecting the auto-complete suggestion (i.e. displayable representation 304) depicted in FIG. 3. As shown in FIG. 4, the originally received textual input is replaced by a representation 402 that enables the multimedia object to be accessed on user interface 102. In one embodiment, the representation 402 may be a link (e.g., a hyperlink) to the stored audio file of the song “Hey Jude” by The Beatles. In another embodiment, the representation 402 may be the multimedia object itself. For example, the suggested audio file of the song “Hey Jude” may be embedded in or attached to the e-mail message.

In some embodiments, displayable representations for multiple multimedia objects may be provided as auto-complete suggestions. Thus, referring back to FIG. 3, displayable representation 304 may include multiple displayable representations in a list or other user-selectable graphical arrangement on user interface 102. For example, the displayable representations can include the audio file of the song “Hey Jude,” a video file of The Beatles performing “Hey Jude,” and an image of the “Hey Jude” album art.

FIGS. 5-7 depict examples of providing auto-completion suggestions based upon results of a mathematical calculation. In FIG. 5, a user has entered the textual input “Hotel room—$225 per night for 4 nights” 502 in a “Notes” application. For example, the user may be working out a budget for an upcoming vacation, and may want to know the total cost of the hotel room.

After the user types the word “nights,” an auto-completion processing may be triggered. For example, electronic device 100 may determine one or more mathematical operations and operands based upon the content of textual input 502. Upon parsing textual input “$225 per night for 4 nights” 502, electronic device 100 may determine that a multiplication operation is to be performed. Electronic device 100 may further determine based upon the parsed textual input that the multiplication operation is to be performed using operands “$225” and “4.” Electronic device 100 may then perform the determined mathematical operation using the operands to produce the result of “$900.”

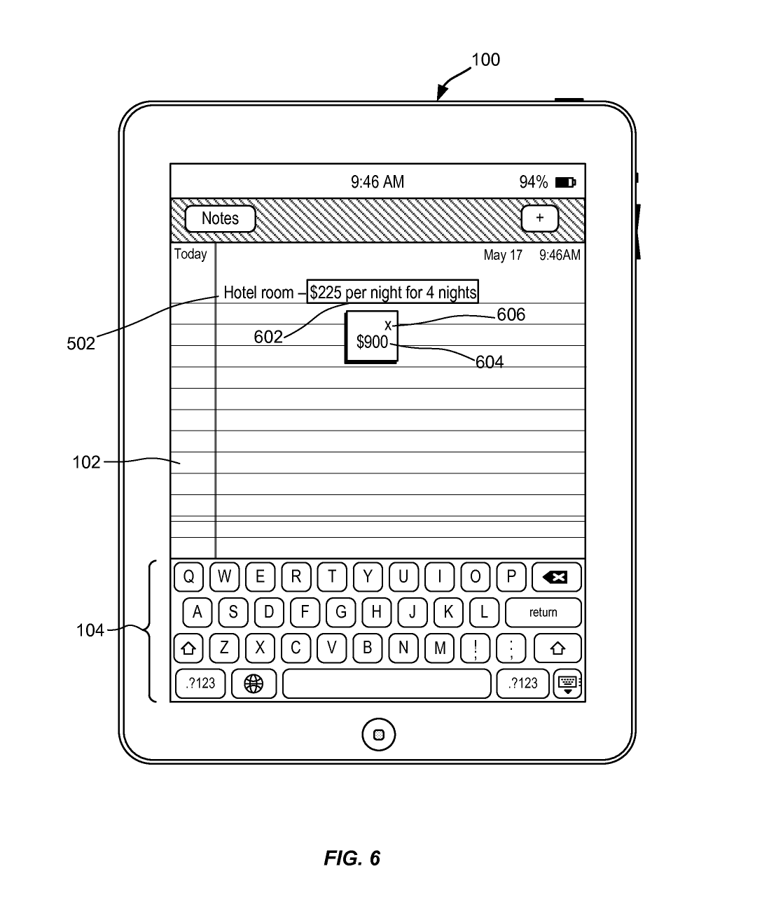

In FIG. 6, electronic device 100 provides the result of the operation as an auto-complete suggestion 604. The result may be provided as a graphical representation and/or a textual representation. In some embodiments, all or part of the original textual input 502 may be highlighted 602, or its appearance altered in some form on user interface 102, to indicate to the user which portions of the original textual input correspond to the auto-completion suggestion 604. For example, as shown in FIG. 6, the textual input “Hotel Room—” is not highlighted but the textual input “$225 per night for 4 nights” 502 is highlighted 602. In other words, electronic device 100 may determine based on the content of textual input 502 which portions should be the subject of an auto-complete suggestion 604.

The user may or may not want to select the auto-complete suggestion 604. As shown in FIG. 6, the auto-complete suggestion 604 may include a control 606 that the user may select using touch input to reject the auto-complete suggestion 604. In some embodiments, the auto-complete suggestion may be rejected by the user using other forms of input such as a keystroke, mouse click, voice input, and the like. For example, if the user continues typing without selecting the auto-complete suggestion 604, the suggestion may be rejected. Moreover, in some embodiments, the auto-complete suggestion 604 may be automatically rejected after the expiration of a predetermined time interval (e.g., a time out functionality). Upon rejection of the auto-complete suggestion 604, it may be removed from (i.e. no longer displayed on) user interface 102.

If the user wishes to replace the highlighted portion 602 of the original textual input 502 with the auto-complete suggestion 604, the user may, for example, provide touch input on user interface 102. For example, the user may touch a region of the auto-completion suggestion 604. In some embodiments, the user may select the auto-complete suggestion 604 by providing other forms of input such as a keystroke, mouse click, voice input, and the like.

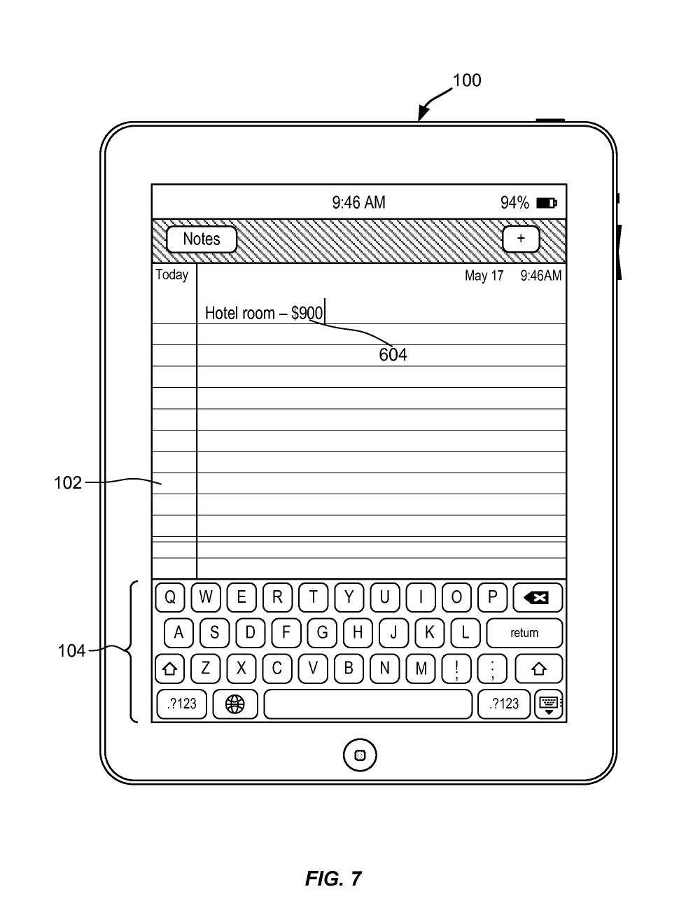

In FIG. 7, electronic device 100 has received input from the user indicating that the user has selected auto-complete suggestion 604. As a result, as shown in FIG. 7, the highlighted portion 602 of the originally received textual input 502 is replaced with the result of the mathematical operation, namely “$900.”

In some embodiments, the electronic device can provide auto-completion suggestions comprising any suitable combination of displayable representations of multimedia objects, results of mathematical operations, and textual auto-completion suggestions for a word or phrase.

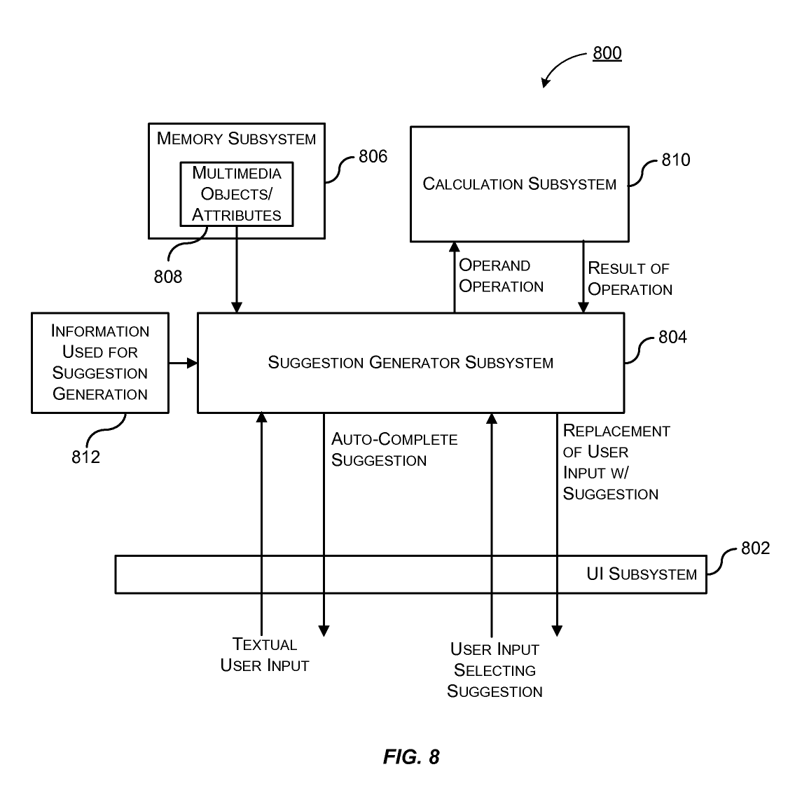

FIG. 8 depicts a simplified diagram of a system 800 that may incorporate an embodiment of the invention. In the embodiment depicted in FIG. 8, system 800 includes multiple subsystems including a user interaction (UI) subsystem 802, a suggestion generator subsystem 804, a memory subsystem 806 storing multimedia objects and multimedia object attributes 808, and a calculation subsystem 810. One or more communication paths may be provided enabling one or more of the subsystems to communicate with and exchange data with one another. One or more of the subsystems depicted in FIG. 8 may be implemented in software, in hardware, or combinations thereof. In some embodiments, the software may be stored on a transitory or non-transitory computer readable medium and executed by one or more processors of system 800.

It should be appreciated that system 800 depicted in FIG. 8 may have other components than those depicted in FIG. 8. Further, the embodiment shown in FIG. 8 is only one example of a system that may incorporate an embodiment of the invention. In some other embodiments, system 800 may have more or fewer components than shown in FIG. 8, may combine two or more components, or may have a different configuration or arrangement of components. In some embodiments, system 800 may be part of an electronic device. For example, system 800 may be part of a portable communications device, such as a mobile telephone, a smart phone, or a multifunction device. Exemplary embodiments of portable devices include, without limitation, the iPhone®, iPod Touch®, and iPad® devices from Apple Inc. of Cupertino, Calif. In some other embodiments, system 800 may also be incorporated in other electronic devices such as desktop computers, kiosks, and the like.

UI subsystem 802 may provide an interface that allows a user to interact with system 800. UI subsystem 802 may output information to the user. For example, UI subsystem 802 may include a display device such as a monitor or a screen. UI subsystem 802 may also enable the user to provide inputs to system 800. In some embodiments, UI subsystem 802 may include a touch-sensitive interface (also sometimes referred to as a touch screen) that can both display information to a user and also receive inputs from the user. For example, in some embodiments, UI subsystem 802 may display auto-complete suggestions including graphical and textual representations. In some other embodiments, UI subsystem 802 may include one or more input devices that allow a user to provide inputs to system 800 such as, without limitation, a mouse, a pointer, a keyboard, or other input device. In certain embodiments, UI subsystem 802 may further include a microphone (e.g., an integrated microphone or an external microphone communicatively coupled to system 800) and voice recognition circuitry configured to facilitate audio-to-text translation. For example, upon receipt of audio input from a user (e.g., a spoken word or phrase) using the microphone, UI subsystem 802 may utilize the voice recognition circuitry to translate the received audio input into textual input.

Memory subsystem 806 may be configured to store data and instructions used by some embodiments of the invention. In some embodiments, memory subsystem 806 may include volatile memory such as random access memory or RAM (sometimes referred to as system memory). Instructions or code or programs that are executed by one or more processors of system 800 may be stored in the RAM. Memory subsystem 806 may also include non-volatile memory such as one or more storage disks or devices, flash memory, or other non-volatile memory devices. In some embodiments, memory subsystem 806 may store multimedia objects and multimedia object attributes 808. Exemplary multimedia objects may include, without limitation, an audio file, a video file, an image, a calendar object (e.g., a calendar invite), a map object, a contact card object, and the like. Multimedia objects may be stored with their corresponding attributes. For example, such attributes may include, without limitation, file names, file sizes, information relating to the content of the object, and the like.

As described above, system 800 may be part of an electronic device. Thus, in some embodiments, memory subsystem 806 may be part of the electronic device. In some embodiments, however, all or part of memory subsystem 806 may be part of a remote server computer (e.g., a web-based server accessible via the internet).

In some embodiments, suggestion generator subsystem 804, memory subsystem 806, and UI subsystem 802, working in cooperation, may be responsible for performing processing related to providing auto-complete suggestions using multimedia objects as described in this disclosure. For example, suggestion generator subsystem 804 can receive textual input from UI subsystem 802, and communicate with memory subsystem 806 to determine one or more multimedia objects based upon the received textual input. Suggestion generator subsystem 804 can generate displayable representations of the determined multimedia objects, and can cooperate with UI subsystem 802 to provide the displayable representations as auto-complete suggestions to a user. Suggestion generator subsystem 804 may further cooperate with UI subsystem 802 to receive user selection of one or more auto-complete suggestions, and to replace all or part of the received textual input with a representation enabling the identified multimedia object to be accessed.

In some embodiments, suggestion generator subsystem 804, UI subsystem 802, and calculation subsystem 810, working in cooperation, may be responsible for performing processing related to providing auto-complete suggestions based upon results of a mathematical calculation as described in this disclosure. For example, suggestion generator subsystem 804 can receive textual input from UI subsystem 802, and determine one or more operands and operations based upon the content of the received textual input. The operands and operations can be passed to calculation subsystem 810 which may perform the operations using the appropriate operands. Suggestion generator subsystem 804 can receive from calculation subsystem 810 the result of the mathematical calculation (e.g., the operations on the operands) performed by calculation subsystem 810, and can cooperate with UI subsystem 802 to provide the result of the mathematical operation as an auto-complete suggestion to the user. Suggestion generator subsystem 804 may further cooperate with UI subsystem 802 to receive user selection of the auto-complete suggestion, and to replace the received textual input with the result of the mathematical calculation.

In certain embodiments, suggestion generator subsystem 804 may use additional information 812 to generate auto-complete suggestions. For example, if system 800 is part of an electronic device, suggestion generator subsystem 804 may communicate with various applications running on the device such as a calendar application, a contacts application, a weather application, a media player application, and the like. As an illustration, to generate an auto-complete suggestion comprising a displayable representation of a calendar object, suggestion generator subsystem 804 may communicate with a calendar application and/or a contacts application running on the device. As another illustration, to generate an auto-complete suggestion comprising a conversion of the current temperature at the geographic location of the electronic device (e.g., from Fahrenheit to Celsius), suggestion generator subsystem 804 may communicate with a weather application.

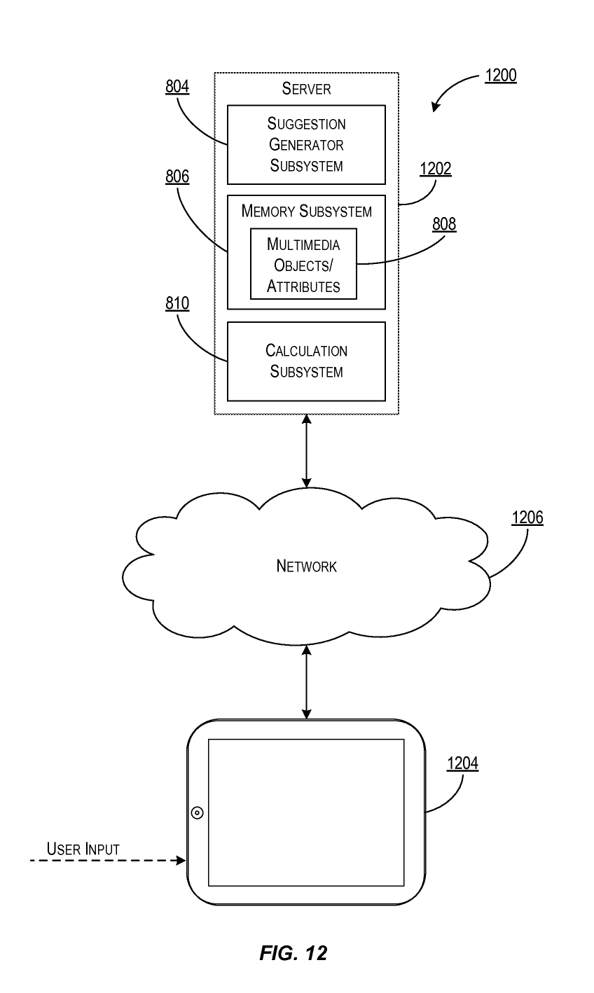

System 800 depicted in FIG. 8 may be provided in various configurations. In some embodiments, system 800 may be configured as a distributed system where one or more components of system 800 are distributed across one or more networks in the cloud. FIG. 12 depicts a simplified diagram of a distributed system 1200 for providing auto-completion suggestions based on multimedia objects or based on the result of a mathematical calculation. In the embodiment depicted in FIG. 12, suggestion generator subsystem 804, memory subsystem 806 storing multimedia objects and multimedia object attributes 808, and calculation subsystem 810 are provided on a server 1202 that is communicatively coupled with a remote client device 1204 via a network 1206.

Network 1206 may include one or more communication networks, which could be the Internet, a local area network (LAN), a wide area network (WAN), a wireless or wired network, an Intranet, a private network, a public network, a switched network, or any other suitable communication network. Network 1206 may include many interconnected systems and communication links including but not restricted to hardwire links, optical links, satellite or other wireless communications links, wave propagation links, or any other ways for communication of information. Various communication protocols may be used to facilitate communication of information via network 1206, including but not restricted to TCP/IP, HTTP protocols, extensible markup language (XML), wireless application protocol (WAP), protocols under development by industry standard organizations, vendor-specific protocols, customized protocols, and others.

In the configuration depicted in FIG. 12, the auto-complete suggestions may be displayed by client device 1204. A user of client device 1204 may use a software keyboard (or other input device) to provide textual input and to select auto-complete suggestions. In one such embodiment, textual input using client device 1204 may be communicated to server 1202 via network 1206. Suggestion generator subsystem 804 on server 1202 may then determine one or more auto-complete suggestions to be displayed by client device 1204. For example, by cooperating with memory subsystem 806, displayable representations of multimedia objects can be communicated to client device 1204 as auto-complete suggestions, and by cooperating with calculation subsystem 810, the result of a mathematical calculation can be communicated to client device 1204 as auto-complete suggestion. Client device 1204 may then display the suggestions to the user via a display, for example.

In the configuration depicted in FIG. 12, suggestion generator subsystem 804, memory subsystem 806, and calculation subsystem 810 are remotely located from client device 1204. In some embodiments, server 1202 may provide auto-completion services to multiple clients. The multiple clients may be served concurrently or in some serialized manner. In some embodiments, the services provided by server 1202 may be offered as web-based or cloud services or under a Software as a Service (SaaS) model.

It should be appreciated that various different distributed system configurations are possible, which may be different from distributed system 1200 depicted in FIG. 12. The embodiment shown in FIG. 12 is thus only one example of a distributed system for providing auto-complete suggestions and is not intended to be limiting.

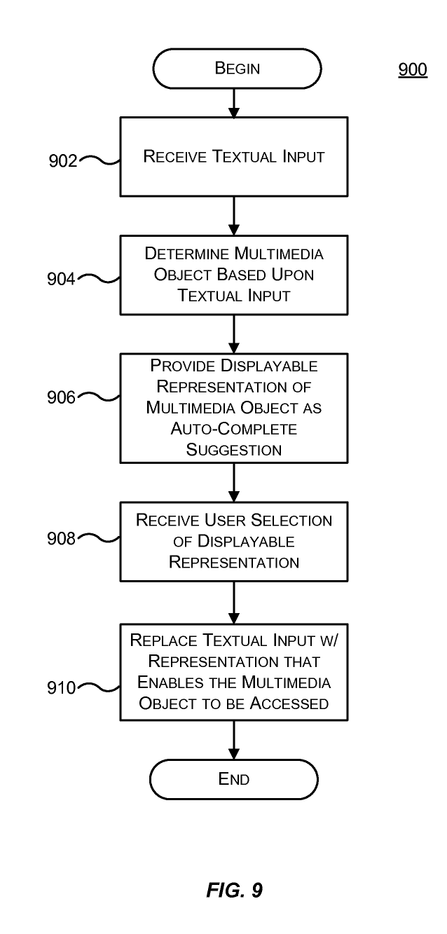

FIG. 9 depicts a simplified flowchart 900 depicting a method of providing auto-completion suggestions using multimedia objects according to embodiments of the invention. The processing depicted in FIG. 9 may be implemented in software (e.g., code, instructions, program) executed by one or more processors, hardware, or combinations thereof The software may be stored on a non-transitory computer-readable storage medium. The particular series of processing steps depicted in FIG. 9 is not intended to be limiting.

As depicted in FIG. 9, at 902, textual input may be received from a user. For example, a user can enter textual input in an application such as a text editor, word processor, web browser, e-mail program, search engine interface, source code editor, database query tool, command line interpreter, and the like. In some embodiments, the textual input can be entered by the user via a keyboard, a software keyboard on a user interface (e.g., software keyboard 104 on user interface 102 shown in FIGS. 1-7), or any other suitable input device. In some embodiments, the textual input can be the result of an audio-to-text translation. For example, upon receipt of audio input from the user (e.g., a spoken word or phrase), the received audio input can be translated into textual input using voice recognition circuitry.

At 904, a multimedia object can be determined based upon the received textual input. For example, as the user enters textual input at 902, an auto-completion processing may be triggered to determine if there is a stored multimedia object that matches the user input. In some embodiments, multimedia objects may be stored in an internal memory. In other embodiments, multimedia objects may be stored externally in a memory of a remote server computer (e.g., a web-based server accessible via the internet). Exemplary multimedia objects may include, but are not limited to, audio files, video files, images, calendar objects, map objects, contact card objects, and the like.

Various different techniques may be used at 904 to determine which multimedia object to select as an auto-complete suggestion. In certain embodiments, the selection may be based upon attributes information stored for the multimedia objects. For example, attributes stored for a set of multimedia objects may include without restriction for each multimedia object, an object name, object size, information about the content of the object, the type of multimedia information stored by the object (e.g., audio, video, etc.), and the like. Using such attributes information, a multimedia object can be identified by “matching” the received textual input with the object's various stored attributes.

In certain embodiments, the auto-completion processing at 904 may involve a “similarity matching” process to compare the received textual input with the stored multimedia object attributes. For example, using similarity matching, matches can be identified by evaluating similarities between the stored object attributes and the received textual input in view of one or more threshold values. If the similarities exceed (or meet) a threshold value, this may constitute a match. It should be noted, however, than any suitable matching technique may be used to identify multimedia objects based upon received textual input.

At 906, a displayable representation of the multimedia object can be provided to the user as an auto-complete suggestion. For example, as shown in FIGS. 1-4, the auto-complete suggestion may be provided on a user interface, and the displayable representation of the multimedia object may comprise a graphical representation (e.g., a graphical image) and/or a textual representation (e.g., one or more words). The displayable representation provides a way of identifying to the user the multimedia object that has been identified as an auto-complete suggestion, and also provides the user a way for selecting the auto-complete suggestion. For example, the user can select the displayable representation of the multimedia object (e.g., by one or more keystrokes, touch input, or other user input) to indicate the user's selection of the multimedia object for auto-completion. In some embodiments, the displayable representation may be displayed as an “inline” auto-complete suggestion (i.e. displayed in the same line of text as the textual input). In other embodiments, the displayable representation may be displayed above or below the textual input.

In certain embodiments, displayable representations of one or more multimedia objects may be provided to the user as auto-complete suggestions at 906. For example, at 904, the auto-completion processing may identify multiple multimedia objects that match the received textual input. The multimedia objects can be ranked (e.g., based on a similarity evaluation), and in certain embodiments, a displayable representation of the highest ranking multimedia object may be provided to the user as an auto-complete suggestion at 906. In certain embodiments, displayable representations of multiple multimedia objects may be provided at 906 (e.g., all of the matching objects identified at 904, or a subset of the matching objects). For example, displayable representations of multiple multimedia objects may be provided to the user as a list or other user-selectable graphical arrangement.

As a non-limiting illustration of 902 to 906, the received textual input at 902 may comprise all or part of an artist's name, a song title, an album name, a movie title, and the like. For example, as described above with respect to FIGS. 1-4, the user may enter the textual input “Hey J” in an e-mail application. Upon input of the character “J,” an auto-completion processing may be triggered. At 904, one or more multimedia objects can be identified as matches based upon a comparison of the textual input with the attributes of stored multimedia objects. At 906, displayable representations of the one or more matching multimedia objects can be provided to the user. For example, a graphical representation of an audio file of the song “Hey Jude,” a video file of The Beatles performing “Hey Jude,” album art images, and other multimedia objects can be provided to the user at a user interface.

As another non-limiting illustration, at 902, the user may enter “I love this song” in an e-mail or other messaging application. At the time the textual input is entered, the user may be listening to a particular song using a media player application. In this illustration, the song may correspond to one or more stored multimedia objects such as an audio file, video files, album art images, etc. Based on the textual input, the multimedia objects can be identified at 904, and the displayable representations of the objects provided to the user as auto-complete suggestions at 906. In some embodiments, received textual input including the word “this” followed by words such as “song,” “track,” “album,” “video,” “clip,” “picture,” “pic,” and the like may trigger auto-completion processing resulting in selection of a multimedia object such as an audio file, video file, and/or image being listened to or viewed by the user when the textual input is received.

As another non-limiting illustration, at 902, the user may enter “Let's meet tomorrow at 2 pm” in an e-mail or other messaging application. In this illustration, a calendar object (e.g., a calendar invite) to the recipient of the message can be generated for the 2 pm meeting at 904. At 906, a displayable representation of the calendar invite can be provided as an auto-complete suggestion. Similarly, if at 902 the user enters “Let's meet with John and Jane tomorrow at 2 pm,” then the user's address book or contacts application can be accessed to determine an e-mail addresses for John and Jane. At 904, a calendar invite to the recipient of the message, John, and Jane for the 2 pm meeting may be generated. In some embodiments, received textual input including the word “meet” followed by dates, times, names, and the like may trigger auto-completion processing using a multimedia object such as a calendar object.

At 908, a user selection of a displayable representation can be received. For example, the user may make a selection by entering touch input on a user interface (e.g., user interface 102 of FIGS. 1-7), or by providing other forms of user input such as a keystroke, mouse click, voice input, and the like. As described above, displayable representations for multiple multimedia objects may be provided to the user as auto-complete suggestions. For example, at 906, a list or other graphical arrangement of displayable representations can be provided. At 908, the user can select one or more of the displayable representations for auto-completion.

In response to the user selection, at 910, all or a portion of the textual input can be replaced with a representation that enables the multimedia object to be accessed. For example, at 910, the received textual input can be replaced with a link (e.g., a hyperlink) to the multimedia object. The link may correspond to a web-based server computer (e.g., hosting a website) from where the multimedia object can be viewed, listened to, purchased, etc. upon selection of the link. In certain embodiments, the textual input can be replaced with the multimedia object itself. For example, the multimedia object can be embedded in or attached to a message (e.g., an e-mail, SMS, instant message, and the like). In certain embodiments, the representation that enables the multimedia object to be accessed may include one or more user controls. For example, if the multimedia object is a video or audio file, the representation may include a graphical “thumbnail” including a user-selectable control allowing the video or audio file to be played, paused, skipped, skipped ahead/back, closed, etc. In another example, if the multimedia object is a map object, the representation may include an image of a map that includes various user-selectable controls such as zoom, pan, scale, rotate, etc.

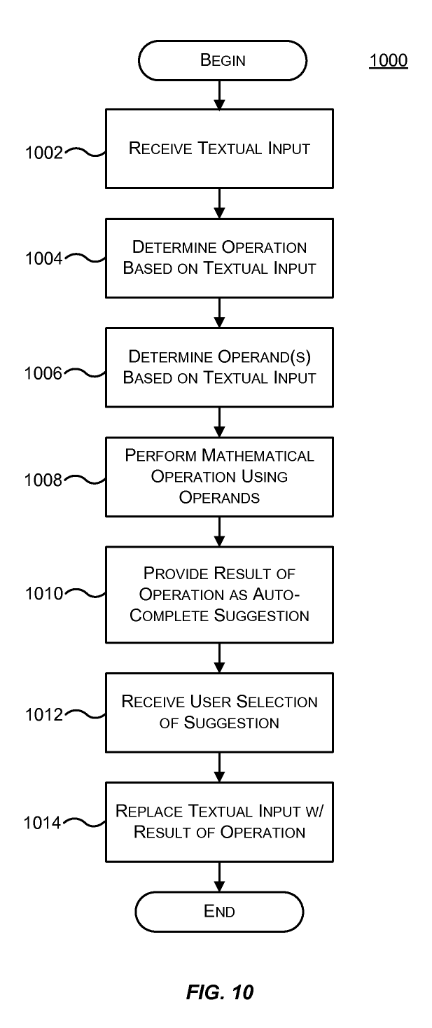

As described above, certain embodiments are further directed to providing auto-completion suggestions based upon the result of a mathematical calculation. FIG. 10 depicts a simplified flowchart 1000 depicting a method of providing auto-completion suggestions using the result of a mathematical calculation according to embodiments of the invention. The processing depicted in FIG. 10 may be implemented in software (e.g., code, instructions, program) executed by one or more processors, hardware, or combinations thereof. The software may be stored on a non-transitory computer-readable storage medium. The particular series of processing steps depicted in FIG. 10 is not intended to be limiting.

As depicted in FIG. 10, at 1002, textual input may be received from a user. For example, a user can enter textual input in an application such as a text editor, word processor, web browser, e-mail program, search engine interface, source code editor, database query tool, command line interpreter, and the like. In some embodiments, the textual input can be entered by the user via a software keyboard on a user interface (e.g., software keyboard 104 on user interface 102 shown in FIGS. 1-7), or any other suitable input device. In some embodiments, the textual input can be the result of an audio-to-text translation. For example, upon receipt of audio input from the user (e.g., a spoken word or phrase), the received audio input can be translated into textual input using voice recognition circuitry.

At 1004, a mathematical operation may be determined based upon the received textual input. In certain embodiments, as the user enters textual input at 1002, an auto-completion processing may be triggered to map the textual input to a mathematical operation. For example, based upon the textual input, a mathematical operation to be performed, and possibly one or more operands to be used for performing the mathematical operation, may be determined. Exemplary mathematical operations may include, but are not limited to, an addition, subtraction, multiplication, division, exponentiation, trigonometric function, unit conversion, currency conversion, interest calculation, and the like.

Certain words, numbers, and symbols included in received textual input may trigger an auto-completion processing using the result of a mathematical calculation, and at 1004, operations may be determined in a number of different ways according to various embodiments of the invention. For example, received textual input including a “+” symbol or the word “plus” may indicate an addition operation, and received textual input including a “−” symbol or the word “minus” may indicate a subtraction operation. Words such as “times,” “per,” and “multiplied” may indicate a multiplication operation, and words such as “divided” or “divided by” may indicate a division operation. In some embodiments, the inclusion of two different units relating to the same property may indicate a unit or currency conversion. For example, the inclusion of both “C” and “F” or “Celsius” and “Fahrenheit” in the same textual input may indicate a temperature conversion, and the inclusion of “dollars” and “yen” in the same textual input may indicate a currency conversion. Operations may be determined based upon received textual input using any suitable processes, and the above-described examples are not intended to be limiting.

In certain embodiments, at 1004, one or more mathematical operations may be identified. For example, at 1004, the auto-completion processing may identify multiple mathematical operations based upon the received textual input. The mathematical operations may be ranked (e.g., according to a determined relevance score), and the highest ranking operation may be selected. In certain embodiments, multiple mathematical operations may be selected at 1004 (e.g., all of the identified operations, or a subset of the operations). As described, below, multiple mathematical operations may be performed to produce a single result, or multiple results.

At 1006, one or more operands may be determined based upon the received textual input, and the operands may be determined in a number of different ways according to various embodiments of the invention. For example, numerical values included in the received textual input may be identified as operands in certain embodiments.

As a non-limiting illustration of 1002 to 1006, the received textual input may include “two plus three.” Thus, at 1004, addition may be identified as the operation, and at 1006, “2” and “3” may be identified as the operands. In some embodiments, more than one operation may be identified. For example, if the received textual input includes “two plus three times four,” then at 1004, both addition and multiplication may be identified as operations, and at 1006, “2,” “3,” and “4” may be identified as operands. In such embodiments, an order of operations may also be determined. In another non-limiting illustration, if the received textual input includes “100 US dollars in yen,” then at 1004, a currency conversion operation (e.g., involving multiplication and/or division operations) may be identified, and at 1006, “100” may be identified as the operand. In another non-limiting illustration, if the received textual input includes “65 degrees Fahrenheit in C.,” then at 1004, a temperature conversion operation may be identified (i.e. the conversion formula (F−32)×5/9)), and at 1006, “65” may be identified as the operand.

At 1008, the determined mathematical operation may be performed using the determined one or more operands to produce a result of the operation. For example, referring to the above-described illustrations, performing the mathematical operation of addition on the operands “2” and “3” will result in “5.” Similarly, performing the temperature conversion operation on the operand “65” will result in “18.3° C.” As described above, for auto-completion processing involving more than one mathematical operation, the order of operations may be determined before performing the operations. In certain embodiments, the received textual input may not include all the required operands, and thus other information may be used to perform a mathematical operation. For example, in the case of a currency conversion, a real-time exchange rate may be determined by accessing published exchange rates on an internet website, a remote server computer, or from any other suitable source.

At 1010, the result of the mathematical operation may be provided to the user as an auto-complete suggestion. For example, as shown in FIGS. 5-7, the auto-complete suggestion may be provided on a user interface as a graphical representation (e.g., a graphical image) and/or a textual representation (e.g., one or more words) of the result of the mathematical operations. In some embodiments, the result of the mathematical operation may be displayed as an “inline” auto-complete suggestion (i.e. displayed in the same line of text as the textual input). In other embodiments, the result of the mathematical operation may be displayed above or below the textual input.

At 1012, a user selection of the auto-complete suggestion may be received. For example, the user may make a selection by providing touch input on a user interface (e.g., user interface 102 of FIGS. 1-7), or by providing other forms of input such as a keystroke, mouse click, voice input, and the like. As described above, results of multiple mathematical operations may be provided to the user as auto-complete suggestions. For example, at 1010, a list or other graphical (or textual) arrangement of auto-completion suggestions may be provided, each including the result of one or more mathematical operations, and at 1012, the user may select one or more of the results for auto-completion.

In response to the user selection, at 1014, all or a portion of the textual input can be replaced by the suggested auto-completion, which is the result of the mathematical calculation.

In various embodiments, any suitable combination of displayable representations of multimedia objects and results of mathematical operations may be provided as auto-complete suggestions. For example, in some embodiments, the same textual input may result in both a displayable representation of a multimedia object and the result of a mathematical calculation being provided as auto-complete suggestions. In some embodiments, a textual auto-completion of a word or phrase may also be provided.

As described above, embodiments of the present invention provide auto-completion techniques wherein displayable representations of multimedia objects and the result of mathematical calculations can be provided as auto-completion suggestions. Such auto-completion techniques may increase typing speed and speed up user-interaction with various applications involving textual input.

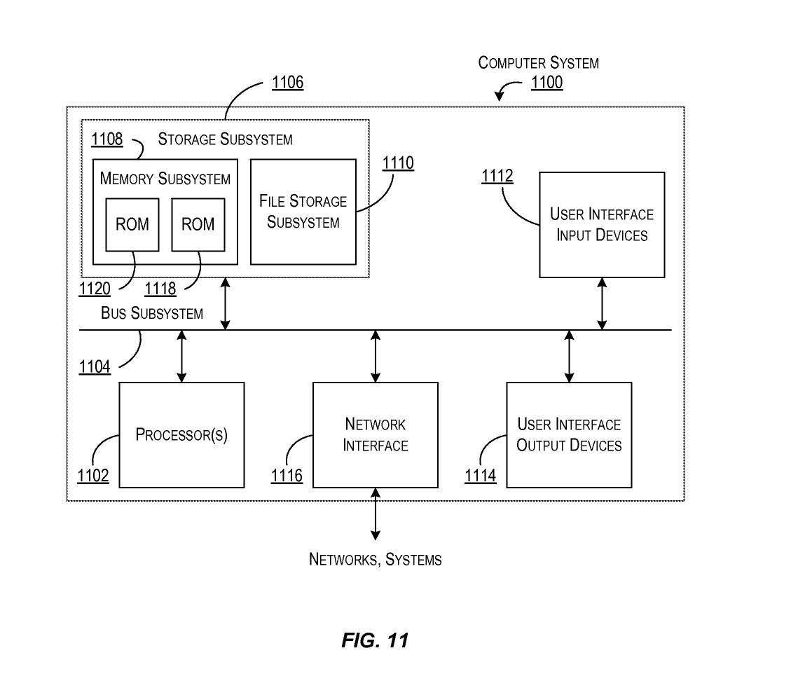

As described above, system 800 of FIG. 8 may incorporate an embodiment of the invention. System 800 may provide the auto-complete suggestions described herein in one or more of the exemplary user interfaces discussed above with respect to FIGS. 1-7 and/or may further provide one or more of the method steps discussed above with respect to FIGS. 9-10. Moreover, system 800 may be incorporated into various systems and devices. For example, FIG. 11 is a simplified block diagram of a computer system 1100 that may incorporate components of system 800 according to some embodiments. As shown in FIG. 11, computer system 1100 includes one or more processors 1102 that communicate with a number of peripheral subsystems via a bus subsystem 1104. These peripheral subsystems may include a storage subsystem 1106, including a memory subsystem 1108 and a file storage subsystem 1110, user interface input devices 1112, user interface output devices 1114, and a network interface subsystem 1116.

Bus subsystem 1104 provides a mechanism for letting the various components and subsystems of computer system 1100 communicate with each other as intended. Although bus subsystem 1104 is shown schematically as a single bus, alternative embodiments of the bus subsystem may utilize multiple busses.

Processor 1102, which can be implemented as one or more integrated circuits (e.g., a conventional microprocessor or microcontroller), controls the operation of computer system 1100. One or more processors 1102 may be provided. These processors may include single core or multicore processors. In various embodiments, processor 1102 can execute a variety of programs in response to program code and can maintain multiple concurrently executing programs or processes. At any given time, some or all of the program code to be executed can be resident in processor(s) 1102 and/or in storage subsystem 1106. Through suitable programming, processor(s) 1102 can provide various functionalities described above.

Network interface subsystem 1116 provides an interface to other computer systems and networks. Network interface subsystem 1116 serves as an interface for receiving data from and transmitting data to other systems from computer system 1100. For example, network interface subsystem 1116 may enable computer system 1100 to connect to one or more devices via the Internet. In some embodiments network interface 1116 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments network interface 1116 can provide wired network connectivity (e.g., Ethernet) in addition to or instead of a wireless interface.

User interface input devices 1112 may include a keyboard, pointing devices such as a mouse or trackball, a touchpad or touch screen incorporated into a display, a scroll wheel, a click wheel, a dial, a button, a switch, a keypad, audio input devices such as voice recognition systems, microphones, and other types of input devices. In general, use of the term “input device” is intended to include all possible types of devices and mechanisms for inputting information to computer system 1100. For example, in an iPhone®, user input devices 1112 may include one or more buttons provided by the iPhone®, a touch screen, which may display a software keyboard, and the like. The software keyboard may include a dynamic character key where a character associated with the dynamic character key can be dynamically changed based upon the context.

User interface output devices 1114 may include a display subsystem, indicator lights, or non-visual displays such as audio output devices, etc. The display subsystem may be a cathode ray tube (CRT), a flat-panel device such as a liquid crystal display (LCD), a projection device, a touch screen, and the like. In general, use of the term “output device” is intended to include all possible types of devices and mechanisms for outputting information from computer system 1400. For example, a software keyboard may be displayed using a flat-panel screen.

Storage subsystem 1106 provides a computer-readable storage medium for storing the basic programming and data constructs that provide the functionality of some embodiments. Storage subsystem 1106 can be implemented, e.g., using disk, flash memory, or any other storage media in any combination, and can include volatile and/or non-volatile storage as desired. Software (programs, code modules, instructions) that when executed by a processor provide the functionality described above may be stored in storage subsystem 1106. These software modules or instructions may be executed by processor(s) 1102. Storage subsystem 1106 may also provide a repository for storing data used in accordance with the present invention. Storage subsystem 1106 may include memory subsystem 1108 and file/disk storage subsystem 1110.

Memory subsystem 1108 may include a number of memories including a main random access memory (RAM) 1118 for storage of instructions and data during program execution and a read only memory (ROM) 1120 in which fixed instructions are stored. File storage subsystem 1110 provides persistent (non-volatile) memory storage for program and data files, and may include a hard disk drive, a floppy disk drive along with associated removable media, a Compact Disk Read Only Memory (CD-ROM) drive, an optical drive, removable media cartridges, and other like memory storage media.

Computer system 1100 can be of various types including a personal computer, a portable device (e.g., an iPhone®, an iPad®), a workstation, a network computer, a mainframe, a kiosk, a server or any other data processing system. Due to the ever-changing nature of computers and networks, the description of computer system 1100 depicted in FIG. 11 is intended only as a specific example. Many other configurations having more or fewer components than the system depicted in FIG. 11 are possible.

Various embodiments described above can be realized using any combination of dedicated components and/or programmable processors and/or other programmable devices. The various embodiments may be implemented only in hardware, or only in software, or using combinations thereof The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof Processes can communicate using a variety of techniques including but not limited to conventional techniques for interprocess communication, and different pairs of processes may use different techniques, or the same pair of processes may use different techniques at different times. Further, while the embodiments described above may make reference to specific hardware and software components, those skilled in the art will appreciate that different combinations of hardware and/or software components may also be used and that particular operations described as being implemented in hardware might also be implemented in software or vice versa.

The various embodiments are not restricted to operation within certain specific data processing environments, but are free to operate within a plurality of data processing environments. Additionally, although embodiments have been described using a particular series of transactions, this is not intended to be limiting.

Thus, although specific invention embodiments have been described, these are not intended to be limiting. Various modifications and equivalents are within the scope of the following claims.

What is claimed is:

1. A method, comprising:
at an electronic device:
outputting a first caption of a plurality of captions while a first segment of a video is being played, wherein the first video segment corresponds to the first caption;
while outputting the first caption, receiving a first user input; and,
in response to receiving the first user input:
determining a second caption in the plurality of captions, distinct from the first caption, that meets predefined caption selection criteria;
determining a second segment of the video that corresponds to the second caption;
sending instructions to change from playing the first segment of the video to playing the second segment of the video; and
outputting the second caption.

2. A method comprising:
receiving, by an electronic device, a textual input;
determining, by the electronic device, a multimedia object based upon the textual input;
providing, by the electronic device, a displayable representation of the multimedia object as an auto-complete suggestion;
receiving, by the electronic device, a user selection of the displayable representation of the multimedia object for auto-completion; and
replacing, by the electronic device, the textual input with a representation that enables the multimedia object to be accessed in response to receiving the user selection.

3. The method of claim 1, wherein the multimedia object is stored in a memory of the electronic device or in a memory of remote server computer.

4. The method of claim 2, wherein the representation that enables the multimedia object to be accessed comprises the multimedia object or a link to the stored multimedia object

5. The method of claim 1, wherein the multimedia object comprises at least one of an audio file, a video file, an image, a calendar object, a map object, or a contact card object.

6. The method of claim 4, wherein the displayable representation is provided as a textual representation or a graphical representation of the multimedia object.

7. A method comprising:
receiving, by an electronic device, a textual input;
performing, by the electronic device, a mathematical operation based upon the textual input;
providing, by the electronic device, a result of the mathematical operation as an auto-complete suggestion;
receiving, by the electronic device, a user selection of the auto-complete suggestion; and
replacing, by the electronic device, the textual input with the result of the mathematical operation in response to receiving the user selection.

8. The method of claim 6, wherein the mathematical operation is determined by the electronic device based upon the textual input.

9. The method of claim 7 further comprising determining, by the electronic device, an operand based upon the textual input, wherein the determined mathematical operation is performed on the operand.

10. The method of claim 6, wherein the mathematical operation comprises one or more of an addition, subtraction, division, multiplication, exponentiation, and a trigonometric function.

11. The method of claim 6, wherein the mathematical operation comprises one or more of a unit conversion, a currency conversion, or an interest calculation.

12. The method of claim 6, wherein the auto-complete suggestion is provided as a textual representation or a graphical representation of the result of the mathematical operation.

13. A computer-readable memory storing a plurality of instructions for controlling one or more processors, the plurality of instructions comprising:
instructions that cause at least one processor from the one or more processors to determine a multimedia object based upon a received textual input;
instructions that cause at least one processor from the one or more processors to provide a displayable representation of the multimedia object as an auto-complete suggestion; and
instructions that cause at least one processor from the one or more processors to replace the textual input with a representation that enables the multimedia object to be accessed in response to receiving a user selection of the displayable representation of the multimedia object.

14. The computer-readable memory of claim 12, wherein the multimedia object is stored in a memory of the electronic device or in a memory of remote server computer.

15. The computer-readable memory of claim 12, wherein the representation that enables the multimedia object to be accessed comprises the multimedia object or a link to the stored multimedia object.

16. The computer-readable memory of claim 12, wherein the multimedia object comprises at least one of an audio file, a video file, an image, a calendar object, a map object, or a contact card object.

17. The computer-readable memory of claim 15, wherein the displayable representation is provided as a textual representation or a graphical representation of the multimedia object.

18. A computer-readable memory storing a plurality of instructions for controlling one or more processors, the plurality of instructions comprising:
instructions that cause at least one processor from the one or more processors to perform a mathematical operation based upon a received textual input;
instructions that cause at least one processor from the one or more processors to provide a result of the mathematical operation as an auto-complete suggestion; and
instructions that cause at least one processor from the one or more processors to replace the user textual input with the result of the mathematical operation in response to receiving a user selection of the auto-complete suggestion.

19. The computer-readable memory of claim 17, wherein the mathematical operation is determined by the electronic device based upon the textual input.

20. The computer-readable memory of claim 18 further comprising determining, by the electronic device, an operand based upon the textual input, wherein the determined mathematical operation is performed on the operand.

21. The computer-readable memory of claim 17, wherein the mathematical operation comprises one or more of an addition, subtraction, division, multiplication, exponentiation, and a trigonometric function.

22. The computer-readable memory of claim 17, wherein the mathematical operation comprises one or more of a unit conversion, a currency conversion, or an interest calculation.

23. The computer-readable memory of claim 17, wherein the auto-complete suggestion is provided as a textual representation or a graphical representation of the result of the mathematical operation.
